(19) United States
(12) Patent Application Publication
(10) Pub. No.: US 2012/0086816 A1
(43) Pub. Date: Apr. 12, 2012

(54) SPEED DOME CAMERA

(75) Inventor: MING-CHIH HSIEH, Tu-Cheng (TW)

(73) Assignee: HON HAI PRECISION INDUSTRY CO., LTD., Tu-Cheng (TW)

(21) Appl. No.: 12/953,253

(22) Filed: Nov. 23, 2010

(30) Foreign Application Priority Data
Oct. 6, 2010 (TW) 99133937

(51) Int. Cl. H04N 5/225

(52) U.S. Cl. 348/207.1; 348/E05.024

(57) ABSTRACT

A camera includes a front portion, a rear portion and a electric brush connecting the front portion and the rear portion. The front portion includes a camera module for capturing image. The front portion further includes a wireless transmission module. The rear portion further includes a wireless receiving module. The front potion sends the image to the wireless receiving module by the wireless transmission module.

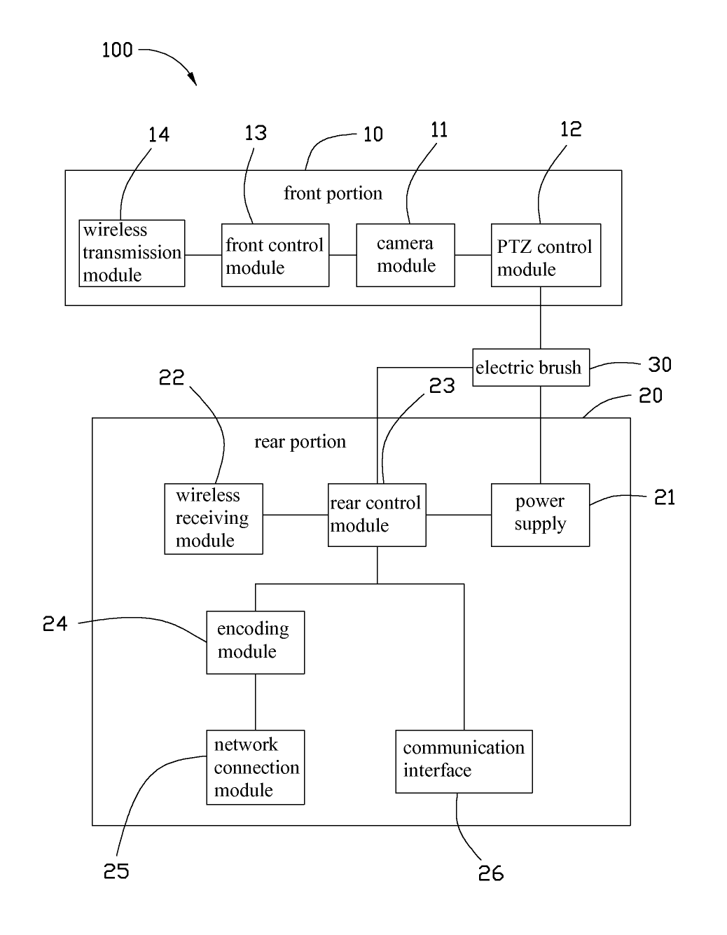

### TECHNICAL FIELD

The disclosure generally relates to cameras, particularly to a speed dome camera.

### DESCRIPTION OF RELATED ART

A speed dome camera typically includes a front portion, a rear portion and a electric brush connecting the front portion and the rear portion. The front portion includes a camera module to capture images. The rear portion controls directions, angle of view and zoom of the camera module. The electric brush, which is a device that conducts current between stationary wires and moving parts, transmits the image from the front portion to the rear portion. The electric brush usually has three pins or twelve pins. Therefore, the image which can be transmitted by the electric brush is limited. When the image is complex such as 8 bytes or 16 bytes of digital of BT-656/601 format, more signal transmission lines are used between the front portion and rear portion, and the image may not be smoothly transmitted by only one electric brush.

Therefore, there is room for improvement within the art.

### BRIEF DESCRIPTION OF THE DRAWINGS

Many aspects of the speed dome camera can be better understood with reference to the following drawings. The components in the drawings are not necessarily drawn to scale, the emphasis instead being placed upon clearly illustrating the principles of the speed dome camera.

The drawing is a block diagram of a speed dome camera, according to an exemplary embodiment.

### DETAILED DESCRIPTION

The drawing shows a speed dome camera 100, according to an exemplary embodiment. The camera 100 includes a front portion 10, a rear portion 20 and an electric brush 30 connecting the front portion 10 and the rear portion 20.

The front portion 10 includes a camera module 11, a pan/tilt/zoom (PTZ) control module 12, a front control module 13 and a wireless transmission module 14. The camera module 11 captures an image, and sends the image to the front control module 13. The PTZ control module 12 controls directions, angle of view and zoom of the camera module 11. The front portion 13 receives the image from the camera module 11 and sends the image to the wireless transmission module 14. The wireless transmission module 14 may be a radio frequency (RF) device, BLUETOOTH device, or a communication device. The wireless transmission module 14 sends the image to the rear portion 20.

The rear portion 20 includes a power supply 21, a wireless receiving module 22, a rear control module 23, an encoding module 24, a network connection module 25 and a communication interface 26. The power supply 21, the wireless receiving module 22, and the communication interface 26 are connected to the rear control module 23. The network connection module 25 is connected to the rear control portion 23 by the encoding module 24. The power supply 21 and the rear control module 23 are connected to the electric brush 30.

The power supply 21 provides electrical power to the rear control portion 23, and supplies electrical power to the front portion 10 with the electric brush 30. The wireless receiving module 22 may be a radio frequency (RF) device, BLUETOOTH device, or other communication device corresponding to the wireless transmission module 14. The wireless receiving module 22 receives the image transmitted from the wireless transmission module 14 and sends the image to the rear control module 23. The rear control portion 23 drives the PTZ control module 12 to control directions, angle of view and zoom of the camera module 11 by the electric brush 30. The rear control module 23 also sends the image to the encoding module 24. The encoding module 24 encodes the image and sends the encoded image to the network connection module 25. The network connection module 25 sends the encoded image to other monitors by a network. The communication interface 26 may be a RS-485 interface, connecting a display to show the image.

To use the camera 100, the camera module 11 captures an image. The image is sent to the wireless receiving module 22 by the wireless transmission module 14. The wireless receiving module 22 sends the image to the rear control module 23. The rear control module 23 encodes the image with the encoding module 24 and sends the encoded image to the network connection module 25 and the communication interface 26. In addition, the power supply 21 provides electrical power to the rear portion 10 by the electric brush 30. The rear control module 23 drives the PTZ control module 12 to control the camera module 11 by the electric brush 30.

The wireless transmission module 14 and the wireless receiving module 22 establish a wireless communication between the front portion 10 and the rear portion 20. The image can be smoothly transmitted without the electric brush 30.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A speed dome camera, comprising:
a front portion including a camera module for capturing an image, the front portion further includes a wireless transmitting module;
a rear portion including a wireless receiving module; and
a electric brush connecting the front portion and the rear portion; wherein, the front potion sends the image to the wireless receiving module by the wireless transmitting module.

2. The speed dome camera as claimed in claim 1, wherein the front portion further includes a front control module set between the camera module and the wireless transmitting module, the front control module sends the image from the camera module to the wireless transmitting module.

3. The speed dome camera as claimed in claim 1, wherein the front portion further includes a PTZ control module connected to the camera module to control direction, angle of view, and zoom of the camera module.

4. The speed dome camera as claimed in claim 3, wherein the rear portion further includes a rear control module connected to the wireless receiving module and the electric brush, the rear control module receives the image from the wireless receiving module, and drives the PTZ control module to control the camera module by the electric brush.

5. The speed dome camera as claimed in claim 4, wherein the rear portion further includes a encoding module and a network connecting module, the encoding module encodes the image and sends the encoded image to the network connecting module.

6. The speed dome camera as claimed in claim 4, wherein the rear portion further includes a power supply connected to the electric brush and the rear control module, the power supply provides electrical power to the rear control portion and also provides to the front portion by the electric brush.

7. The speed dome camera as claimed in claim 4, wherein the rear portion further includes a communication interface connected to the rear control module for connecting a display.

8. The speed dome camera as claimed in claim 7, wherein the communication interface is a RS-485 interface.

9. The speed dome camera as claimed in claim 1, wherein the wireless transmission module and the wireless receiving module are a radio frequency device, a BLUETOOTH device, or a communication device.
